(19) United States
(12) Patent Application Publication
(10) Pub. No.: US 2024/0345447 A1
(43) Pub. Date: Oct. 17, 2024

(54) DIMMING STRUCTURE AND DIMMING DEVICE

(71) Applicants: Beijing BOE Technology Development Co., Ltd., Beijing (CN); BOE Technology Group Co., Ltd., Beijing (CN)

(72) Inventors: Jiangbo CHEN, Beijing (CN); Fanli MENG, Beijing (CN); Zeyuan LI, Beijing (CN); Qiuyun TAN, Beijing (CN)

(73) Assignees: Beijing BOE Technology Development Co., Ltd., Beijing (CN); BOE Technology Group Co., Ltd., Beijing (CN)

(21) Appl. No.: 18/682,120

(22) PCT Filed: Jun. 30, 2022
(86) PCT No.: PCT/CN2022/102942

§ 371 Date: Feb. 8, 2024

(51) Int. Cl. G02F 1/155; G02F 1/133

(52) U.S. Cl. CPC G02F 1/155; G02F 1/13324

(57) ABSTRACT

A dimming structure and a dimming device are provided. The dimming structure includes a positive current collector layer, a positive pole, an electrolyte layer, and a negative current collector layer; the positive current collector layer is connected to a first positive pole of a power supply; the positive pole is provided on a side of the positive current collector layer; the electrolyte layer is provided on a side of the positive pole away from the positive current collector layer; the negative current collector layer is provided on a side of the electrolyte layer away from the positive current collector layer and is connected to a first negative pole of the power supply; the positive current collector layer and the negative current collector layer are conductors; the positive current collector layer, the positive pole, the electrolyte layer, and the negative current collector layer are all light-transmissive layers.

### CROSS REFERENCE TO RELATED APPLICATION

The present disclosure is the U.S. national phase application of International Application No. PCT/CN2022/102942 filed on Jun. 30, 2022, the content of which is incorporated herein by reference in its entirety for all purposes.

### TECHNICAL FIELD

The present disclosure relates to the field of electrochromic technology, in particular to a dimming structure and a dimming device.

### BACKGROUND

The principle of the electrochromism is that an electrochromic material undergoes an electrochemical oxidation-reduction reaction under the action of an external electric field, which changes the color of the material by gaining or losing electrons. The electrochromism refers to a phenomenon in which the optical properties (reflectivity, transmittance, absorption rate, etc.) of the material undergo stable and reversible color changes under the action of the external electric field, manifested as reversible changes in color and transparency in appearance. Materials with electrochromic properties are called electrochromic materials, and a device made from electrochromic materials is called an electrochromic device.

It should be noted that the information disclosed in the above section is only intended to enhance the understanding of the background of the present disclosure, and thus can include information that does not constitute the prior art already known to those skilled in the art.

### SUMMARY

According to one aspect of the present disclosure, a dimming structure is provided, including: a positive current collector layer configured to be connected with a first positive pole of a power supply; a positive pole arranged on a side of the positive current collector layer; an electrolyte layer arranged on a side of the positive pole away from the positive current collector layer; and a negative current collector layer arranged on a side of the electrolyte layer away from the positive current collector layer, and configured to be connected with a first negative pole of the power supply; wherein the positive current collector layer and the negative current collector layer are conductors, and the positive current collector layer, the positive pole, the electrolyte layer, and the negative current collector layer are all light transmissive layers.

According to one aspect of the present disclosure, a dimming device is provided, including: a dimming structure including: a positive current collector layer configured to be connected with a first positive pole of a power supply; a positive pole arranged on a side of the positive current collector layer; an electrolyte layer arranged on a side of the positive pole away from the positive current collector layer; and a negative current collector layer arranged on a side of the electrolyte layer away from the positive current collector layer, and configured to be connected with a first negative pole of the power supply; wherein the positive current collector layer and the negative current collector layer are conductors, and the positive current collector layer, the positive pole, the electrolyte layer, and the negative current collector layer are all light transmissive layers; a power supply electrically connected to the dimming structure; and electric equipment electrically connected to the dimming structure.

It should be understood that the general description above and the detailed description in the following are only illustrative and explanatory, and do not limit the present disclosure.

### BRIEF DESCRIPTION OF THE DRAWINGS

The drawings, which are incorporated in and constitute a part of this specification, illustrate embodiments consistent with the present disclosure and serve together with the specification to explain principles of the present disclosure. It is apparent that the drawings in the following description are only some embodiments of the present disclosure, and for those of ordinary skill in the art, other drawings can also be obtained from these drawings without creative efforts.

FIG. 1 is a schematic structural diagram of a first example dimming structure according to embodiments of the present disclosure.

FIG. 2 is a schematic diagram of a principle of reduction in transmittance of the dimming structure in FIG. 1.

FIG. 3 is a schematic diagram of a principle of improvement in transmittance of the dimming structure in FIG. 1.

FIG. 4 is a schematic diagram of a change relationship curve between a light transmissive wavelength and the transmittance of the dimming structure in FIG. 1 at 0V and 4.5V voltages.

FIG. 5 is a schematic diagram of a change relationship between transmittance comparison and the wavelength of the two curves in FIG. 4.

FIG. 6 is a schematic structural diagram of a second example dimming structure according to embodiments of the present disclosure.

FIG. 7 is a schematic structural diagram of a third example dimming structure according to embodiments of the present disclosure.

FIG. 8 is a schematic structural diagram of a fourth example dimming structure according to embodiments of the present disclosure.

FIG. 9 is a schematic structural diagram of a fifth example dimming structure according to embodiments of the present disclosure.

FIG. 10 is a schematic structural diagram of a sixth example dimming structure according to embodiments of the present disclosure.

FIG. 11 is a schematic structural diagram of a seventh example dimming structure according to embodiments of the present disclosure.

FIG. 12 is a schematic structural diagram of an eighth example dimming structure according to embodiments of the present disclosure.

FIG. 13 is a schematic structural diagram of a first example dimming device according to embodiments of the present disclosure.

FIG. 14 is a schematic structural diagram of a second example dimming device according to embodiments of the present disclosure.

FIG. 15 is a schematic structural diagram of a third example dimming device according to embodiments of the present disclosure.

FIG. 16 is a schematic structural diagram of a fourth example dimming device according to embodiments of the present disclosure.

FIG. 17 is a schematic structural diagram of a fifth example dimming device according to embodiments of the present disclosure.

### EXPLANATIONS OF REFERENCE NUMERALS

10. Dimming structure;
101. First base substrate; 102. Second base substrate;
12. Positive current collector layer; 121. First via hole;
13. Positive pole; 14. Electrolyte layer; 15. Negative current collector layer;
16. First conductive enhancement layer; 161. Second via hole;
17. Second conductive enhancement layer;
181. First encapsulation layer; 182. Second encapsulation layer; 183. Third encapsulation layer;
20. Solar cells;
21. Positive electrode; 22. Hole transport layer; 23. Photoelectric conversion layer; 24. Electron transport layer; 25. Negative electrode;
R. Electric equipment.

### DETAILED DESCRIPTION

Example embodiments will now be described more fully with reference to the drawings. However, the example embodiments can be implemented in a variety of forms and should not be construed as being limited to the embodiments set forth herein. Rather, the provision of these embodiments makes the present disclosure comprehensive and complete and conveys ideas of the example embodiments in a comprehensive manner to those skilled in the art. The same reference numerals in the drawings indicate the same or similar structures, and thus their detailed description will be omitted. In addition, the drawings are only schematic illustrations of the present disclosure and are not necessarily drawn to scale.

Although relative terms such as “upper” and “lower” are used in this specification to describe a relative relationship of one component and another component, these terms are used in this specification only for convenience, for example, according to a direction of the example shown in the drawings. It will be appreciated that if the device illustrated is turned upside down, the component described as “upper” will become the “lower” component. When a certain structure is “on” another structure, it may mean that the certain structure is integrally formed on the other structure, or it may mean that the certain structure is “directly” arranged on the other structure, or that the certain structure is “indirectly” arranged on the other structure through yet another structure.

Terms “a”, “an”, “the”, “said” and “at least one” are used to indicate presence of one or more elements/components/etc. Terms “include” and “comprise” are used to indicate an open-ended inclusion, and mean presence of additional elements/components/etc., in addition to listed elements/components/etc. Terms “first”, “second”, “third”, etc., are used as markings only, instead of limiting the quantity of objects.

In the present disclosure, unless otherwise specified and limited, the term “connection” should be understood broadly. For example, the “connection” can be a fixed connection, a detachable connection, or as a whole. It can be directly connected or indirectly connected through intermediate media.

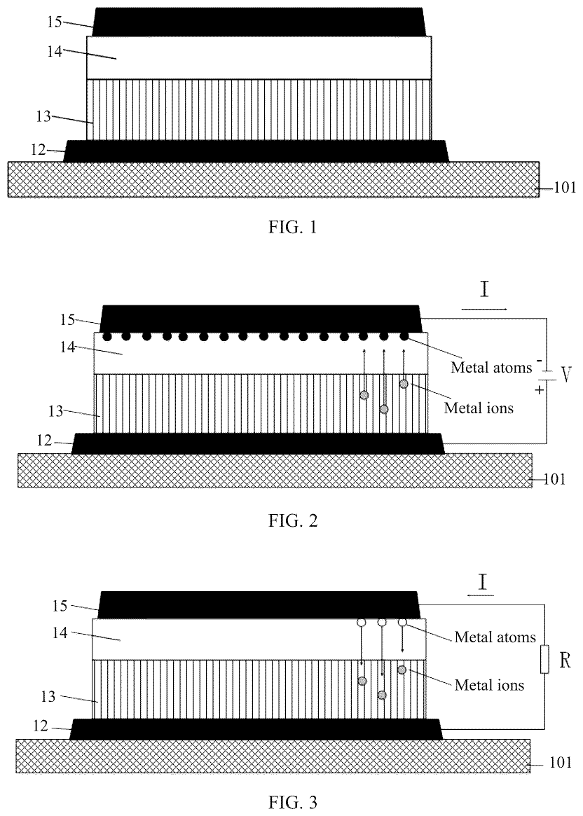

Embodiments of the present disclosure provide a dimming structure 10, as shown in FIGS. 1 to 12. The dimming structure 10 can include a positive current collector layer 12, a positive pole 13, an electrolyte layer 14, and a negative current collector layer 15. The positive current collector layer 12 can be configured to be connected with a first positive pole of a power supply. The positive pole 13 is arranged on a side of the positive current collector layer 12. The electrolyte layer 14 is arranged on a side of the positive pole 13 away from the positive current collector layer 12. The negative current collector layer 15 is arranged on a side of the electrolyte layer 14 away from the positive current collector layer 12, and is configured to be connected with a first negative pole of the power supply. In some embodiments, the positive current collector layer 12 and the negative current collector layer 15 are conductors, while the positive current collector layer 12, the positive pole 13, the electrolyte layer 14, and the negative current collector layer 15 are all light transmissive layers.

The dimming structure 10 of the present disclosure is in a high transmittance state, as each layer thereof is a light transmissive layer. As shown in FIG. 2, after the positive current collector layer 12 and the negative current collector layer 15 are energized, metal ions in the positive pole 13 and/or the electrolyte layer 14 are reduced to metal atoms and deposited on a side of the negative current collector layer 15 close to the electrolyte layer 14, so as to reduce the transmittance of the dimming structure 10 and achieve the goal of adjusting the transmittance. On the other hand, a thickness of the metal atoms deposited can be controlled by controlling a duration and a current magnitude for energizing the positive current collector layer 12 and the negative current collector layer 15, thereby achieving the goal of freely adjusting the transmittance. On the other hand, as shown in FIG. 3, the reduced metal atoms can store energy, and after the dimming structure 10 is connected to the electric equipment R, the metal atoms can lose electrons and become metal ions, and the metal ions return to the positive pole 13, increasing the transmittance of the dimming structure 10.

As shown in FIG. 1, in embodiments of the present disclosure, the dimming structure 10 can include a first base substrate 101. A material of the first base substrate 101 can be a light transmissive material. For example, the first base substrate 101 can be inorganic glass, organic polymer, or a fiber and nanocomposites. The organic polymer can specifically include polyethylene terephthalate (PET), polymethyl methacrylate (PMMA), polystyrene (PS), polycarbonate (PC), and polydiallyl glycol carbonate (CR-39), and the like. The fiber and nanocomposites can specifically include transparent fiberglass. The transmittance of the first base substrate 101 is greater than or equal to 80% and less than or equal to 100%.

It should be noted that a transmittance greater than 20% can be classified as the light transmissive material, and a film layer with a transmittance greater than 20% can be defined as a light transmissive layer.

The positive current collector layer 12 is arranged on a side of the first base substrate 101, and the positive current collector layer 12 is a light transmissive layer. That is, the material of the positive current collector layer 12 is a light transmissive material. The transmittance of the positive current collector layer 12 is greater than or equal to 20% and less than or equal to 100%. The positive current collector layer 12 is a conductive layer. That is, the material of the positive current collector layer 12 is a conductive material. For example, the material of the positive current collector layer 12 can be metal materials such as Mo, Al, Cu, Au, Ti, Pt, etc. In embodiments of the present disclosure, the material of the positive current collector layer 12 is a metal material of Cu. To ensure the transmittance of the positive current collector layer 12, the thickness of the positive current collector layer 12 is greater than 0 nanometers and less than or equal to 100 nanometers. For example, the thickness of the positive current collector layer 12 can be of 5 nanometers, 10 nanometers, 16 nanometers, 20 nanometers, 23 nanometers, 28.4 nanometers, 30 nanometers, 35 nanometers, 41 nanometers, 49 nanometers, 52 nanometers, 58 nanometers, 64 nanometers, 67 nanometers, 70 nanometers, 85 nanometers, 88.6 nanometers, 90 nanometers, 92 nanometers, 98 nanometers, etc. The positive current collector layer 12 can be configured to be connected to the first positive pole of the power supply, or a second positive pole of the electric equipment R.

In some embodiments of the present disclosure, the material of the positive current collector layer 12 can be graphene, which can be formed through Plasma Enhanced Chemical Vapor Deposition (PECVD) method, the method being of high color grade and having good film quality. The graphene is a new generation of transparent conductive materials. In the visible light band, the transmittance of four layers of graphene (the single layer of graphene has a thickness of about 0.335 nm, and four layers of graphene has a thickness of about 1.34 nm) is comparable to the transmittance of a traditional ITO film (ITO film has a thickness of about 135 nm). The thickness of the ITO film has little effect on the transmittance thereof. In other bands, the transmittance of four layers of graphene is much higher than the transmittance of the ITO film. The graphene is almost completely transparent, with a transmittance thereof being up to 97.4%. In some embodiments, the graphene serves as the positive current collector layer 12, with a thickness greater than or equal to 0.335 nm and less than or equal to 3.335 nm.

The positive pole 13 is arranged on a side of the positive current collector layer 12 away from the first base substrate 101. The positive pole 13 is a light transmissive layer, that is, the material of the positive pole 13 is a light transmissive material. The transmittance of the positive pole 13 is greater than or equal to 20% and less than or equal to 100%. The positive pole 13 is a conductive layer, that is, the material of the positive pole 13 is a conductive material. For example, the material of the positive pole 13 is LiCoO₂, LiMnO₂, etc. Due to the low transmittance and grayish black color of LiCoO₂ and LiMnO₂, when the material of the positive pole 13 is LiCoO₂ or LiMnO₂, the thickness of the positive pole 13 is greater than 0 micrometer but less than or equal to 1 micrometer. For example, the thickness of the positive pole 13 can be 10 nanometers, 16 nanometers, 20 nanometers, 30 nanometers, 35 nanometers, 40 nanometers, 60 nanometers, 80 nanometers, 100 nanometers, 132 nanometers, 158 nanometers, 224 nanometers, 267 nanometers, 370 nanometers, 485 nanometers, 588.6 nanometers, 690 nanometers, 792 nanometers, 898 nanometers, 972 nanometers, etc. The positive pole 13 can be configured to provide metal ions.

In some embodiments of the present disclosure, the material of the positive pole 13 can be LiV₃O₈, Li₄Ti₅O₁₂, TiO₂, V₂O₅, etc., which can be formed through the sputtering process. The transmittance of TiO₂ is about 80%, and the transmittance of V₂O₅ is about 60%. TiO₂ and V₂O₅ have higher transmittance, which can improve the overall transmittance of the dimming structure 10. The thickness of TiO₂ is greater than 0 micrometers and less than or equal to 100 micrometers. For example, the thickness of TiO₂ can be 0.5 micrometers (500 nanometers), 4 micrometers, 18 micrometers, 20.4 micrometers, 30.5 micrometers, 20.7 micrometers, 24 micrometers, 31 micrometers, 45 micrometers, 48 micrometers, 50 micrometers, 56 micrometers, 67 micrometers, 78 micrometers, 85 micrometers, 87 micrometers, 91 micrometers, 95 micrometers, etc.

The electrolyte layer 14 is arranged on a side of the positive pole 13 away from the first base substrate 101. The electrolyte layer 14 is a light transmissive layer, that is, the material of the electrolyte layer 14 is a light transmissive material. The transmittance of the electrolyte layer 14 is greater than or equal to 20% and less than or equal to 100%. The electrolyte layer 14 adopts a transparent solid electrolyte, for example, the material of the electrolyte layer 14 can be LLZO, LLTO, LiPO₃, LiPON, etc. The thickness of the electrolyte layer 14 is greater than 0 micron and less than or equal to 10 microns. For example, the thickness of the electrolyte layer 14 can be 10 nanometers, 16 nanometers, 120 nanometers, 300 nanometers, 350 nanometers, 400 nanometers, 600 nanometers, 800 nanometers, 1000 nanometers, 1320 nanometers, 3158 nanometers, 4224 nanometers, 4267 nanometers, 5370 nanometers, 5485 nanometers, 6588.6 nanometers, 7690 nanometers, 8792 nanometers, 8898 nanometers, 9972 nanometers, etc. The electrolyte layer 14 is equivalent to a resistor, avoiding a short circuit caused by the connection between the negative current collector layer 15 and the positive pole 13, and providing deposition space for metal ions. Moreover, in some embodiments, the electrolyte layer 14 can also serve to provide metal ions.

In some embodiments of the present disclosure, the material of the positive pole 13 can be a solid sodium positive pole, a solid lithium positive pole, a solid aluminum positive pole, a solid magnesium positive pole, or a solid potassium positive pole. The solid sodium positive pole can provide sodium ions, the solid lithium positive pole can provide lithium ions, the solid aluminum positive pole can provide aluminum ions, the solid magnesium positive pole can provide magnesium ions, and the solid potassium positive pole can provide potassium ions. For example, the solid sodium positive pole can be sodium transition metal oxides, sodium transition metal phosphates, sodium transition metal sulfates, sodium transition metal Prussian blue compounds, etc., from which materials with higher transmittance can be selected.

The material of the electrolyte layer 14 can be sodium ion electrolyte, lithium ion electrolyte, aluminum ion electrolyte, magnesium ion electrolyte, potassium ion electrolyte, etc. For example, the sodium ion electrolyte can be Na-β-Al₂O₃, NASICON, sulfide sodium ion solid electrolyte, etc.

In the case where the material of the positive pole 13 is a solid sodium positive pole and the material of the electrolyte layer 14 is a sodium ion electrolyte, the materials of the positive current collector layer 12 and the negative current collector layer 15 can be Al, with a thickness greater than 0 nanometer and less than or equal to 100 nanometers. For example, the thickness of the negative current collector layer 15 can be 5 nanometers, 10 nanometers, 16 nanometers, 20 nanometers, 23 nanometers, 28.4 nanometers, 30 nanometers, 35 nanometers, 41 nanometers, 49 nanometers, 52 nanometers, 58 nanometers, 64 nanometers, 67 nanometers, 70 nanometers, 85 nanometers, 88.6 nanometers, 90 nanometers, 92 nanometers, 98 nanometers, etc.

The negative current collector layer 15 is arranged on a side of the electrolyte layer 14 away from the first base substrate 101. The negative current collector layer 15 is a light transmissive layer, which means that the negative current collector layer 15 can transmit light. The transmittance of the negative current collector layer 15 is greater than or equal to 20% and less than or equal to 100%. The negative current collector layer 15 is a conductive layer, that is, the material of the negative current collector layer 15 is a conductive material. For example, the material of the negative current collector layer 15 is metal materials such as Cu, Au, Ti, Pt, etc. In embodiments of the present disclosure, the material of the negative current collector layer 15 is a metal material of Cu. To ensure the transmittance of the negative current collector layer 15, the thickness of the negative current collector layer 15 is greater than 0 nanometer and less than or equal to 100 nanometers. For example, the thickness of the negative current collector layer 15 can be 5 nanometers, 10 nanometers, 16 nanometers, 20 nanometers, 23 nanometers, 28.4 nanometers, 30 nanometers, 35 nanometers, 41 nanometers, 49 nanometers, 52 nanometers, 58 nanometers, 64 nanometers, 67 nanometers, 70 nanometers, 85 nanometers, 88.6 nanometers, 90 nanometers, 92 nanometers, 98 nanometers, etc. The negative current collector layer 15 can be configured to be connected to the first negative pole of the power supply, or a second negative pole of the electric equipment R.

In some embodiments of the present disclosure, the material of the negative current collector layer 15 can be graphene, which can be formed through Plasma Enhanced Chemical Vapor Deposition (PECVD) method, the method being of high color grade and having good film quality. The graphene is a new generation of transparent conductive materials. In the visible light band, the transmittance of four layers of graphene is comparable to the transmittance of a traditional ITO film. In other bands, the transmittance of four layers of graphene is much higher than the transmittance of the ITO film. The graphene is almost completely transparent, with a transmittance thereof being up to 97.4%. In embodiments of the present disclosure, graphene serves as the negative current collector layer 15, with a thickness greater than or equal to 0.335 nm and less than or equal to 3.35 nm.

The dimming principle of the dimming structure 10 is as follows: after the positive current collector layer 12 and the negative current collector layer 15 of the dimming structure 10 are energized, Li⁺ (lithium ion) in the positive pole 13 diffuses through the electrolyte layer 14 under the action of an electric field, to the vicinity of the negative current collector layer 15. Li⁺ (lithium ion) is reduced to a Li atom by supplementing electrons through the negative electrode current collector 15. That is, the Li atom is deposited on a side of the transparent negative electrode current collector 15 close to the positive pole 13, resulting in a decrease in the transmittance of the dimming structure 10. As the amount of Li atoms deposited increases, the negative current collector layer 15 is completely covered by Li atoms to form a Li metal layer. The transmittance of the dimming structure 10 decreases to the lowest value, and the transmittance can be reduced to nearly 1%.

In some embodiments, depending on the material of the positive pole 13, the metal ions contained are different (such as sodium ions, aluminum ions, potassium ions, etc.), and the metal atoms deposited (such as sodium atoms, aluminum atoms, potassium atoms, etc.) are also different, forming different metal layers (such as a sodium layer, an aluminum layer, a potassium layer, etc.).

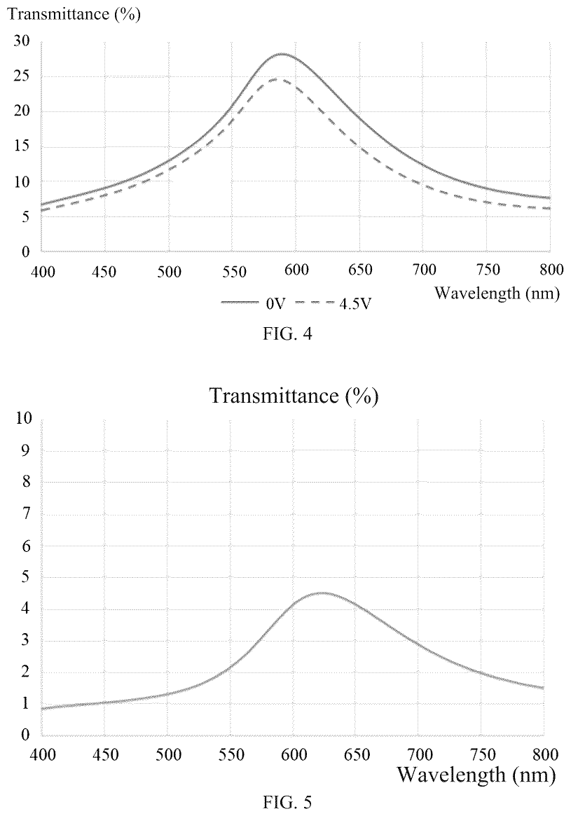

Referring to the schematic diagram of a change relationship curve between a light transmissive wavelength and the transmittance of the dimming structure shown in FIG. 4 at 0V and 4.5V voltages, it can be seen from the drawings that the transmittance is relatively high in the entire visible light band, and the wavelength of the visible light is about greater than or equal to 0.39 μm and less than or equal to 0.76 μm, with the highest transmittance being around 620 nanometers. The voltage is increased to 4.5V, then the transmittance will be reduced by about 5%. In some embodiments of the present disclosure, the transmittance can be reduced by about 50%.

Referring to the schematic diagram of a change relationship between transmittance comparison and the wavelength of the two curves in FIG. 4 as shown in FIG. 5. It can be seen from the drawings that the maximum reduction in the transmittance is around 620 nanometers, and the transmittance will be reduced by about 5%.

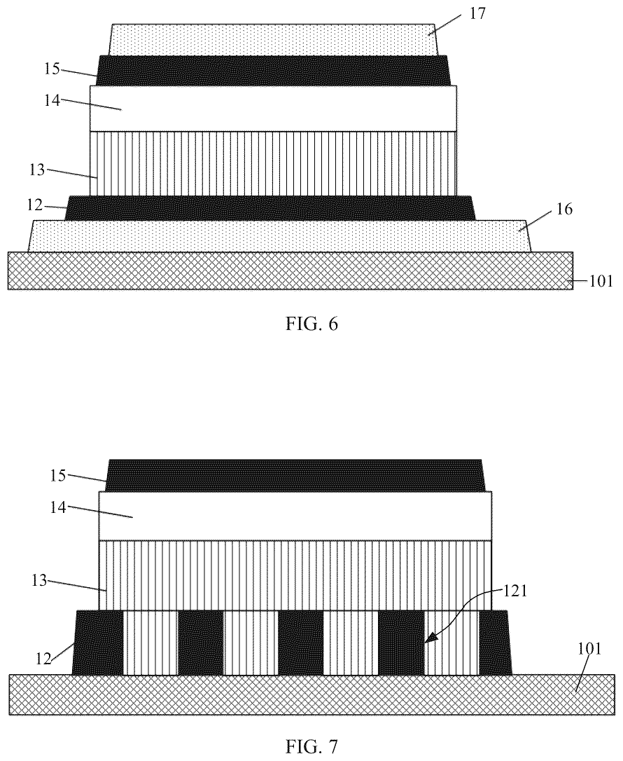

As shown in FIG. 6, the positive current collector layer 12 can be provided as a composite layer. In some embodiments, the dimming structure 10 can further include a first conductive enhancement layer 16, which can be arranged adjacent to the positive current collector layer 12. For example, the first conductive enhancement layer 16 can be arranged on a side of the positive current collector layer 12 away from the positive pole 13, that is, the first conductive enhancement layer 16 can be arranged between the positive current collector layer 12 and the first base substrate 101. In some embodiments, the first conductive enhancement layer 16 can be arranged on a side of the positive current collector layer 12 close to the positive pole 13. The first conductive enhancement layer 16 is a light transmissive layer, that is, the first conductive enhancement layer 16 can transmit light. The transmittance of the first conductive enhancement layer 16 is greater than or equal to 20% and less than or equal to 100%. Moreover, the first conductive enhancement layer 16 is a conductive layer, that is, a material of the first conductive enhancement layer 16 is a conductive material. For example, the material of the first conductive enhancement layer 16 can be transparent conductive materials such as ITO (Indium Tin Oxide), AZO, etc. AZO is an abbreviation for aluminum doped zinc oxide (ZnO) transparent conductive glass. A thickness of the first conductive enhancement layer 16 is greater than 0 micrometer and less than or equal to 1 micrometer. For example, the thickness of the first conductive enhancement layer 16 can be 10 nanometers, 16 nanometers, 20 nanometers, 30 nanometers, 35 nanometers, 40 nanometers, 60 nanometers, 80 nanometers, 100 nanometers, 135 nanometers, 158 nanometers, 224 nanometers, 267 nanometers, 370 nanometers, 485 nanometers, 588.6 nanometers, 690 nanometers, 792 nanometers, 898 nanometers, 972 nanometers, etc.

The negative current collector layer 15 can also be provided as a composite layer. In some embodiments, the dimming structure 10 can further include a second conductive enhancement layer 17, which is arranged adjacent to the negative current collector layer 15. For example, the second conductive enhancement layer 17 can be arranged on a side of the negative current collector layer 15 away from the electrolyte layer 14. In some embodiments, the second conductive enhancement layer 17 can be arranged on a side of the negative current collector layer 15 close to the electrolyte layer 14, that is, the second conductive enhancement layer 17 can be arranged between the negative current collector layer 15 and the electrolyte layer 14. The second conductive enhancement layer 17 is a light transmissive layer, that is, the second conductive enhancement layer 17 can transmit light. Moreover, the second conductive enhancement layer 17 is a conductive layer, that is, a material of the second conductive enhancement layer 17 is a conductive material. For example, the material of the second conductive enhancement layer 17 can be ITO (Indium Tin Oxide), AZO, etc. AZO is an abbreviation for aluminum doped zinc oxide (ZnO) transparent conductive glass. A thickness of the second conductive enhancement layer 17 is greater than 0 micrometer and less than or equal to 1 micrometer. For example, the thickness of the second conductive enhancement layer 17 can be 10 nanometers, 16 nanometers, 20 nanometers, 30 nanometers, 35 nanometers, 40 nanometers, 60 nanometers, 80 nanometers, 100 nanometers, 135 nanometers, 158 nanometers, 224 nanometers, 267 nanometers, 370 nanometers, 485 nanometers, 588.6 nanometers, 690 nanometers, 792 nanometers, 898 nanometers, 972 nanometers, etc.

As shown in FIG. 7, the positive current collector layer 12 can be patterned, that is, the positive current collector layer 12 can be provided as a pattern. In some embodiments, multiple first via holes 121 can be arranged in the positive current collector layer 12, and the multiple first via holes 121 can be arranged in an array or arranged arbitrarily according to requirements. The shape of a cross section of the first via hole 121 parallel to a surface of the first base substrate 101 close to the positive current collector layer 12 can be circular, elliptical, various polygons, etc. In the case where the first via hole 121 is a circular via hole, a diameter of the first via hole 121 is greater than or equal to 1 micrometer and less than or equal to 1 millimeter. For example, the diameter of the first via hole 121 can be 4 micrometers, 18 micrometers, 30.4 micrometers, 80.5 micrometers, 120.7 micrometers, 214 micrometers, 311 micrometers, 451 micrometers, 483 micrometers, 564 micrometers, 671 micrometers, 783 micrometers, 854 micrometers, 876 micrometers, 901 micrometers, 950 micrometers, etc. A distance between adjacent first via holes 121 can be provided according to needs. By providing the first via hole 121 in the positive current collector layer 12, the transmittance of the positive current collector layer 12 can be improved, thereby improving the transmittance of the entire dimming structure 10.

Moreover, with such arrangement, some of the positive poles 13 are located inside the first via holes 121, allowing for more materials for the positive pole 13 to be provided while the overall thickness of the dimming structure 10 remains unchanged. As a result, more metal ions can be provided, so that the metal ions pass through the negative current collector layer 15 to supplement electrons and to form more metal atoms. The metal atoms cover the negative current collector layer 15, resulting in lower transmittance and better dimming effect of the dimming structure 10, which also enables the dimming structure 10 to store more energy while maintaining its overall volume unchanged.

The method for forming the first via hole 121 can be as follows: depositing a current collector material layer for the positive pole 13 on the first base substrate 101, coating the photoresist on the current collector material layer for the positive pole 13, placing a mask on a side of the photoresist away from the current collector material layer for the positive pole 13, exposing and developing the photoresist with the mask, and finally etching the current collector material layer for the positive pole 13 by using the photoresist as the mask to form the positive current collector layer 12.

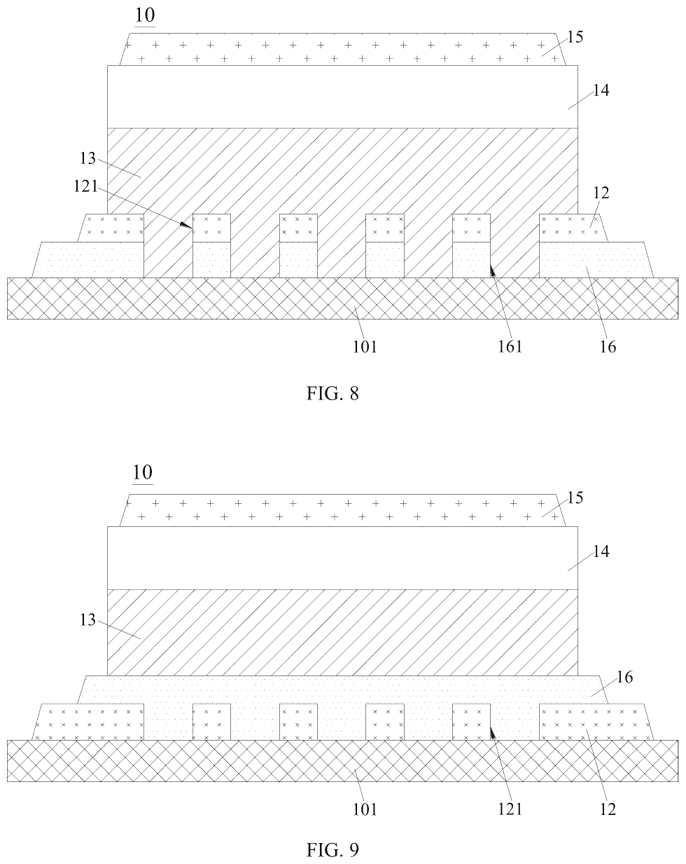

Referring to FIG. 8, in the case where a first conductive enhancement layer 16 is provided, the first conductive enhancement layer 16 can be patterned, that is, the first conductive enhancement layer 16 can be provided as a pattern. In some embodiments, multiple second via holes 161 can be arranged in the first conductive enhancement layer 16, and the multiple second via holes 161 can be arranged in an array or arranged arbitrarily according to requirements. The shape of a cross section of the second via hole 161 parallel to the surface of the first base substrate 101 close to the positive current collector 12 can be circular, elliptical, various polygons, etc. The second via holes 161 and the first via holes 121 can be formed through the same photolithography process. Therefore, the shape of the second via hole 161 can be the same as that of the first via hole 121, and the size of the second via hole 161 can be the same as that of the first via hole 121. That is, in the case where the second via hole 161 is a circular via hole, a diameter of the second via hole 161 is greater than or equal to 1 micrometer and less than or equal to 1 millimeter, and specific values will not be repeated here. In some embodiments, the second via holes 161 and the first via holes 121 can be formed through different photolithography processes. Therefore, the shape of the second via hole 161 can be different from that of the first via hole 121, and the size of the second via hole 161 can be different from that of the first via hole 121.

In some embodiments of the present disclosure, in the case where a first conductive enhancement layer 16 is provided, no second via holes 161 are be provided in the first conductive enhancement layer 16. Due to the high transmittance of the first conductive enhancement layer 16, absence of the second via hole 161 in the first conductive enhancement layer 16 has a relatively small impact on the overall transmittance of the dimming structure 10.

In some embodiments, as shown in FIG. 9, in the case where the first conductive enhancement layer 16 is arranged on a side of the positive current collector layer 12 away from the first base substrate 101, a portion of the first conductive enhancement layer 16 can be arranged inside the first via holes 121, that is, a portion of materials of the first conductive enhancement layer 16 can be filled into the first via holes 121. On the one hand, since the first conductive enhancement layer 16 is also made of conductive materials, the resistance of the positive current collector layer 12 can be reduced and the conductivity of the positive current collector layer 12 can be improved through the first conductive enhancement layer 16. On the other hand, since the transmittance of the first conductive enhancement layer 16 is high, the impact of the first conductive enhancement layer 16 on the transmittance at the first via hole 121 is relatively small, ensuring the transmittance at the first via hole 121. As a result, the transmittance of the dimming structure 10 can be improved while ensuring the conductivity of the positive current collector layer 12.

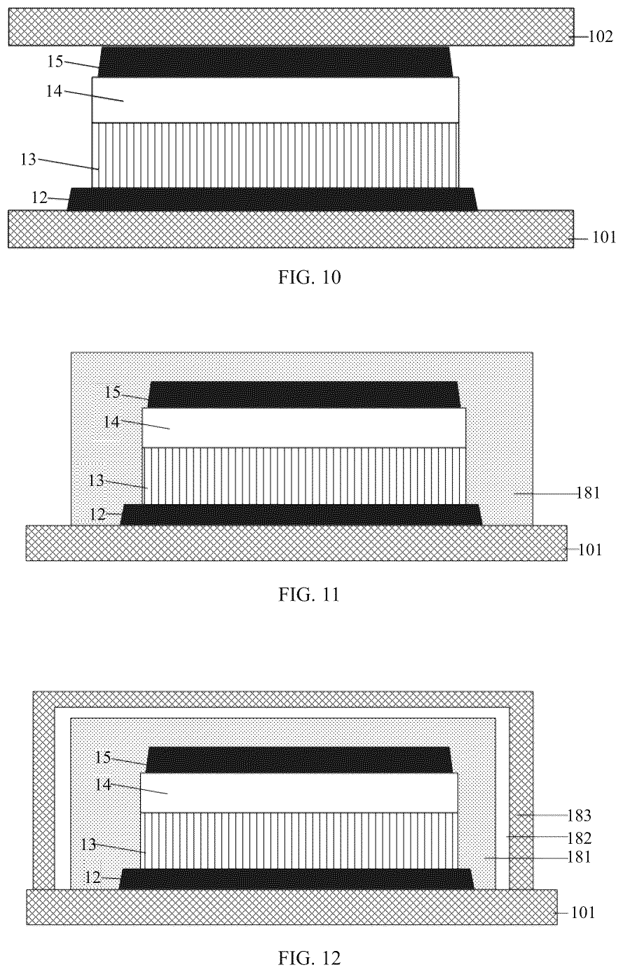

As shown in FIG. 10, the dimming structure 10 can further include a second base substrate 102, which is arranged on a side of the negative current collector layer 15 away from the electrolyte layer 14. The positive current collector layer 12, the positive pole 13, the electrolyte layer 14, and the negative current collector layer 15 are clamped between the first base substrate 101 and the second base substrate 102. The strength of the dimming structure 10 can be ensured through the first base substrate 101 and the second base substrate 102.

A material of the second base substrate 102 can be a light transmissive material. For example, the material of the second base substrate 102 can be inorganic glass, organic polymers, or fibers and nanocomposites. The organic polymers can specifically include polyethylene terephthalate (PET), polymethyl methacrylate (PMMA), polystyrene (PS), polycarbonate (PC), and polydiallyl glycol carbonate (CR-39), etc. The fibers and nanocomposites can be transparent fiberglass.

As shown in FIG. 11, the dimming structure 10 can further include a first encapsulation layer 181, and the encapsulation layer 181 can wrap the positive current collector layer 12, the positive pole 13, the electrolyte layer 14, and the negative current collector layer 15. In some embodiments, the first encapsulation layer 181 can include a first encapsulation plate and a first encapsulation cylinder. The first encapsulation cylinder has a first end and a second end arranged opposite to each other. The first encapsulation plate is connected to the first end of the first encapsulation cylinder, and the second end of the first encapsulation cylinder is connected to one side of the first base substrate 101. The first encapsulation plate is located on a side of the negative current collector 15 away from the first base substrate 101, and the first encapsulation cylinder is arranged on side walls of the positive current collector layer 12, the positive pole 13, the electrolyte layer 14, and the negative current collector layer 15.

The first encapsulation layer 181 is made of a transparent material. For example, the material of the first encapsulation layer 181 can be LiPON (lithium phosphate), PDMS (polydimethylsiloxane), Al₂O₃, SiN, SiON, SiO₂, organic adhesive, etc. When the organic adhesive material is used as the material of the first encapsulation layer 181, it can be directly coated on outer sides of the positive current collector layer 12, the positive pole 13, the electrolyte layer 14, and the negative current collector layer 15. When the inorganic material is used as the material of the first encapsulation layer 181, it can be deposited on the outer sides of the positive current collector layer 12, the positive pole 13, the electrolyte layer 14, and the negative current collector layer 15.

As shown in FIG. 12, the dimming structure 10 can further include a second encapsulation layer 182, and the second encapsulation layer 182 can wrap the first encapsulation layer 181. In some embodiments, the second encapsulation layer 182 can include a second encapsulation plate and a second encapsulation cylinder. The second encapsulation cylinder has a third end and a fourth end arranged opposite to each other. The second encapsulation plate is connected to the third end of the second encapsulation cylinder, and the fourth end of the second encapsulation cylinder is connected to one side of the first base substrate 101. The second encapsulation plate is located on a side of the first encapsulation plate away from the first base substrate 101, and the second encapsulation cylinder is arranged on a side wall of the first encapsulation cylinder away from the positive current collector layer 12.

The second encapsulation layer 182 is made of a transparent material. For example, the material of the second encapsulation layer 182 can be LiPON (lithium phosphate), PDMS (polydimethylsiloxane), Al₂O₃, SiN, SiON, SiO₂, organic adhesive, etc. When the organic adhesive material is used as the material of the second encapsulation layer 182, it can be directly coated on outer sides of the positive current collector layer 12, the positive pole 13, the electrolyte layer 14, and the negative current collector layer 15. When the inorganic material is used as the material of the second encapsulation layer 182, it can be deposited on the outer sides of the positive current collector layer 12, the positive pole 13, the electrolyte layer 14, and the negative current collector layer 15.

Reference is continued to be made to FIG. 12, the dimming structure 10 can further include a third encapsulation layer 183, and the third encapsulation layer 183 can wrap the second encapsulation layer 182. In some embodiments, the third encapsulation layer 183 can include a third encapsulation plate and a third encapsulation cylinder. The third encapsulation cylinder has a fifth end and a sixth end arranged opposite to each other. The third encapsulation plate is connected to the fifth end of the third encapsulation cylinder, and the sixth end of the third encapsulation cylinder is connected to one side of the first base substrate 101. The third encapsulation plate is located on a side of the second encapsulation plate away from the first base substrate 101, and the third encapsulation cylinder is arranged on a side wall of the second encapsulation cylinder away from the positive current collector layer 12.

The third encapsulation layer 183 is made of a transparent material. For example, the material of the third encapsulation layer 183 can be LiPON (lithium phosphate), PDMS (polydimethylsiloxane), Al₂O₃, SiN, SiON, SiO₂, organic adhesive, etc. When the organic adhesive material is used as the material of the third encapsulation layer 183, it can be directly coated on the outer sides of the positive current collector layer 12, the positive pole 13, the electrolyte layer 14, and the negative current collector layer 15. When the inorganic material is used as the material of the third encapsulation layer 183, it can be deposited on the outer sides of the positive current collector layer 12, the positive pole 13, the electrolyte layer 14, and the negative current collector layer 15.

The dimming structure is encapsulated through the first encapsulation layer 181, the second encapsulation layer 182, and the third encapsulation layer 183, not only the dimming structure can be protected and the strength of the dimming structure can be improved, but also the water vapor can be prevented from entering the interior of the dimming structure, which may cause water oxygen corrosion to the internal film layers.

In some embodiments, the first encapsulation layer 181 can be SiO₂, the second encapsulation layer 182 can be SiON, and the third encapsulation layer 183 can be SiN. Such arrangement has good waterproof performance. In some embodiments, the first encapsulation layer 181 can be inorganic materials, the second encapsulation layer 182 can be organic materials, and the third encapsulation layer 183 can be inorganic materials. The organic material can buffer the stress of the inorganic material.

In some embodiments of the present disclosure, more encapsulation layers can be arranged, which will not be repeated here.

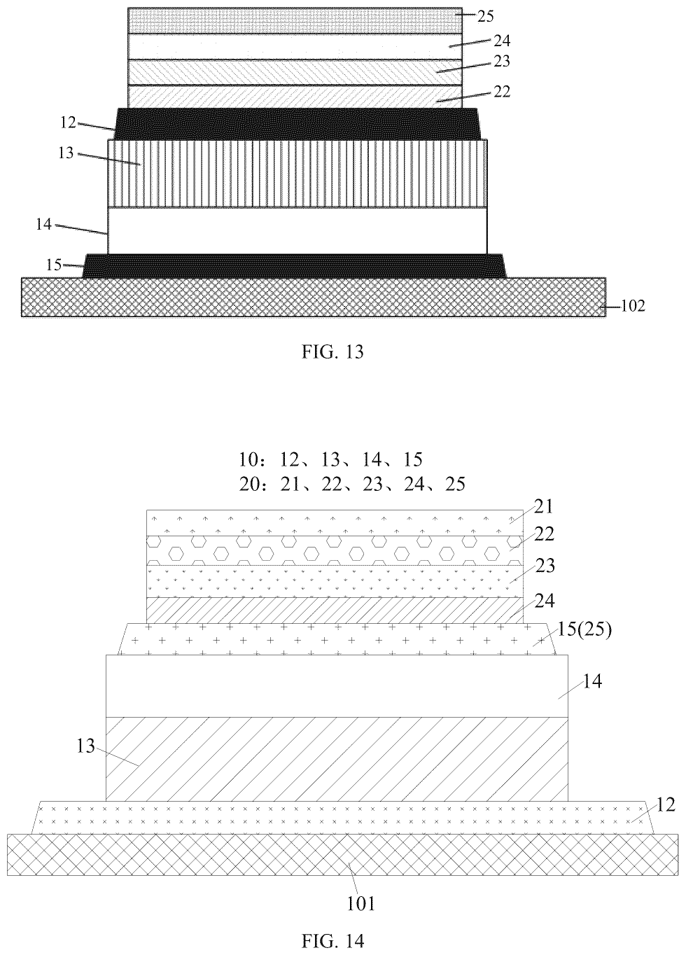

Based on the same invention concept, embodiments of the present disclosure provide a dimming device, as shown in FIGS. 13-17. The dimming device can include any of dimming structures 10 as described above. The specific structure of dimming structure 10 has been explained in detail above, and thus it will not be repeated here.

The dimming device can further include a power supply and electric equipment R, with the power supply being electrically connected to the dimming structure 10. The electric equipment R is electrically connected to the dimming structure 10. The electric equipment R can include various electric equipment such as a resistor, a heater, a fan, etc.

The power supply can include a solar cell 20. The solar cell 20 can include a positive electrode 21 and a negative electrode 25. The positive electrode 21 is electrically connected to the positive current collector layer 12. In some embodiments, the positive electrode 21 can be connected to the positive current collector layer 12 through a conductive wire. The negative electrode 25 is electrically connected to the negative current collector layer 15. In some embodiments, the negative electrode 25 can be connected to the negative current collector layer 15 through a conductive wire. The solar cell 20 can provide the power supply to the dimming structure 10, and the electrical energy generated by the solar cell 20 can be stored in the dimming structure 10.

In some embodiments, the solar cell 20 can further include a hole transport layer 22, a photoelectric conversion layer 23, an electron transport layer 24, etc. arranged in stacked manner in sequence. The hole transport layer 22 is connected to the positive electrode 21. The photoelectric conversion layer 23 is arranged on a side of the hole transport layer 22. The electron transport layer 24 is arranged on a side of the photoelectric conversion layer 23 away from the hole transport layer 22, and is connected to the negative electrode 25.

As shown in FIGS. 13 and 14, the solar cell 20 and the dimming structure 10 can be arranged in stacked manner. As shown in FIG. 13, the dimming structure 10 can include a second base substrate 102, a negative current collector layer 15, an electrolyte layer 14, a positive pole 13, and a positive current collector layer 12 arranged in stacked manner in sequence. Their specific structures have been explained in detail above, and thus they will not be repeated here.

The hole transport layer 22 can be arranged on a side of the positive current collector layer 12 away from the positive pole 13. An orthographic projection of the hole transport layer 22 on the positive current collector layer 12 overlaps with an orthographic projection of the positive pole 13 on the positive current collector layer 12. The photoelectric conversion layer 23 is arranged on a side of the hole transport layer 22 away from the positive pole 13, the electron transport layer 24 is arranged on a side of the photoelectric conversion layer 23 away from the positive pole 13, and the negative electrode 25 is arranged on a side of the electron transport layer 24 away from the positive pole 13. The positive current collector layer 12 of the dimming structure 10 is multiplexed as the positive electrode 21 of the solar cell 20. That is, the positive current collector layer 12 not only serves to be connected with the positive pole 13, but also to be connected with the hole transport layer 22.

In some embodiments, as shown in FIG. 14, the dimming structure 10 can include a first base substrate 101, a positive current collector layer 12, a positive pole 13, an electrolyte layer 14, and a negative current collector layer 15 arranged in stacked manner in sequence. In this case, the electron transport layer 24 can be arranged on a side of the negative current collector layer 15 away from the electrolyte layer 14, and an orthographic projection of the electron transport layer 24 on the positive current collector layer 12 overlaps with an orthographic projection of the electrolyte layer 14 on the positive current collector layer 12. The photoelectric conversion layer 23 is arranged on a side of the electron transport layer 24 away from the electrolyte layer 14, the hole transport layer 22 is arranged on a side of the photoelectric conversion layer 23 away from the electrolyte layer 14, and the positive electrode 21 is arranged on a side of the hole transport layer 22 away from the electrolyte layer 14. The negative current collector layer 15 of the dimming structure 10 is multiplexed as the negative electrode 25 of the solar cell 20. That is, the negative current collector layer 15 not only serves to be connected with the electrolyte layer 14, but also to be connected with the electron transport layer 24.

In some embodiments, in the case shown in FIGS. 13 and 14, in order to ensure that the light can pass through the dimming structure 10, the hole transport layer 22, the photoelectric conversion layer 23, the electron transport layer 24, and the negative electrode 25 are all provided as light transmissive layers. That is, the materials of the hole transport layer 22, the photoelectric conversion layer 23, the electron transport layer 24, and the negative electrode 25 are all light transmissive materials. In some embodiments, the material of the hole transport layer 22 can be MoO₃, the material of the photoelectric conversion layer 23 can be PDTP-DFBT: FOIC (PDTP-DFBT is a narrow bandgap polymer donor, and FOIC is a narrow bandgap non fullerene acceptor), the material of the electron transport layer 24 can be ZnO, and the material of the negative electrode 25 can be ITO. In some embodiments, the material of the positive current collector layer 12 can be Ag. Other materials can also be chosen, and they will not be repeated here.

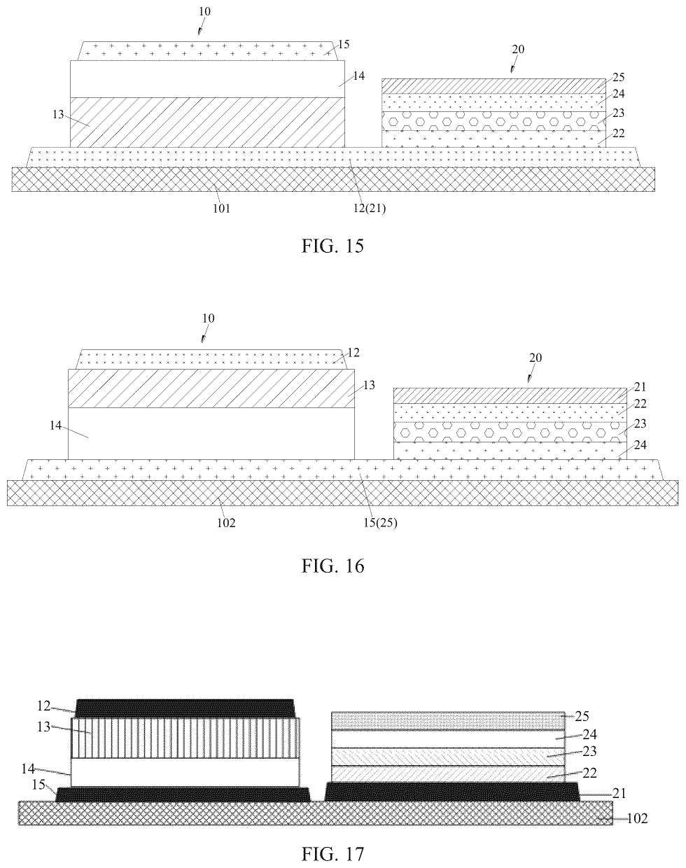

Referring to FIGS. 15 and 16, the solar cell 20 can be arranged side by side with the dimming structure 10. As shown in FIG. 15, the dimming structure 10 can include a first base substrate 101, a positive current collector layer 12, a positive pole 13, an electrolyte layer 14, and a negative current collector layer 15 arranged in stacked manner in sequence. Their specific structures have been explained in detail above, and thus they will not be repeated here.

The hole transport layer 22 is arranged on one side of the positive current collector layer 12. In some embodiments, the hole transport layer 22 is arranged on a side of the positive current collector layer 12 away from the first base substrate 101. An orthographic projection of the hole transport layer 22 on the positive current collector layer 12 does not overlap with an orthographic projection of the positive pole 13 on the positive current collector layer 12. The photoelectric conversion layer 23 is arranged on a side of the hole transport layer 22 away from the positive current collector layer 12, the electronic transport layer 24 is arranged on a side of the photoelectric conversion layer 23 away from the positive current collector layer 12, and the negative electrode 25 is arranged on a side of the electronic transport layer 24 away from the positive current collector layer 12. The positive current collector layer 12 of the dimming structure 10 is multiplexed as the positive electrode 21 of the solar cell 20. That is, the positive current collector layer 12 not only serves to be connected with the positive pole 13, but also to be connected with the hole transport layer 22.

In some embodiments, as shown in FIG. 16, the dimming structure 10 can include a second base substrate 102, a negative current collector layer 15, an electrolyte layer 14, a positive pole 13, and a positive current collector layer 12 arranged in stacked manner in sequence. In this case, an area of the negative current collector layer 15 is provided to be larger. The electron transport layer 24 is arranged on a side of the negative current collector layer 15, and an orthographic projection of the electron transport layer 24 on the negative current collector layer 15 does not overlap with an orthographic projection of the electrolyte layer 14 on the negative current collector layer 15. The photoelectric conversion layer 23 is arranged on a side of the electron transport layer 24 away from the negative current collector layer 15, the hole transport layer 22 is arranged on a side of the photoelectric conversion layer 23 away from the negative current collector layer 15, and the positive electrode 21 is arranged on a side of the hole transport layer 22 away from the negative current collector layer 15. The negative current collector layer 15 of the dimming structure 10 is multiplexed as the negative electrode 25 of the solar cell 20. That is, the negative current collector layer 15 not only serves to be connected with the electrolyte layer 14, but also to be connected with the electron transport layer 24.

As shown in FIG. 17, a gap can be provided between the dimming structure 10 and the solar cell 20, which means that the dimming structure 10 and the solar cell 20 are arranged in separated manner, with no film layers being multiplexed.

It should be noted that in the cases shown in FIGS. 15, 16, and 17, the layers of solar cell 20 can be provided to be non-light transmissive, which will not affect the dimming function of dimming structure 10. The solar cell 20 can use perovskite solar cells, amorphous silicon solar cells, polycrystalline silicon solar cells, monocrystalline silicon solar cells, and so on.

The principle of the dimming device is that when at night and there is no sunlight, the solar cell 20 does not output a voltage, and the dimming structure 10 does not receive a voltage input. Therefore, the negative current collector layer 15 does not have deposited Li, and the dimming structure 10 is in a high transmittance state, and the transmittance is determined by the transmittance of each film layer. When the sun begins to rise, the solar cell 20 receives a trace of light and outputs a certain amount of energy to the dimming structure 10. The dimming structure 10 is in a charging state, and Li is gradually deposited on the negative current collector layer 15. The dimming structure 10 is in a semi transmittance state. Then at noon, the solar cell 20 receives the maximum energy and provides the highest output, and the dimming structure 10 is fully charged. The amount of Li deposited on the negative current collector layer 15 increases, completely isolating the external environmental light, and the dimming structure 10 is in a completely non-light transmissive state. This non-light transmissive state can be maintained and no additional energy drive is required. The dimming structure 10 will be able to perform storage, and the power generation can be achieved when the dimming structure 10 is connected with the electric equipment R. Moreover, the automatic control of indoor lighting can be achieved, and a solution that integrates energy storage, dimming, and power generation can be achieved through two devices.

In some embodiments, other power supplies can also be used, such as dry batteries, regular mains power, etc.

After considering the specification and practicing of the invention disclosed herein, those skilled in the art will easily come up with other implementation solutions of the present disclosure. The present disclosure aims to cover any variations, uses, or adaptive changes of the present disclosure, which follow the general principles of the present disclosure and include common knowledge or commonly used technical means in the art that are not disclosed in the present disclosure. The specification and embodiments are only considered exemplary, and the true scope and spirit of the present disclosure are defined by appended claims.

1. A dimming structure, comprising:
a positive current collector layer configured to be connected with a first positive pole of a power supply;
a positive pole arranged on a side of the positive current collector layer;
an electrolyte layer arranged on a side of the positive pole away from the positive current collector layer; and
a negative current collector layer arranged on a side of the electrolyte layer away from the positive current collector layer, and configured to be connected with a first negative pole of the power supply;
wherein the positive current collector layer and the negative current collector layer are conductors, and the positive current collector layer, the positive pole, the electrolyte layer, and the negative current collector layer are all light transmissive layers.

2. The dimming structure according to claim 1, wherein the positive current collector layer is provided with a patterned structure, and the dimming structure further comprises:
a first base substrate arranged on a side of the positive current collector layer away from the positive pole.

3. The dimming structure according to claim 2, wherein multiple first via holes are arranged in the positive current collector layer, and a portion of the positive pole is located inside the first via holes.

4. The dimming structure according to claim 1, further comprising:
a first conductive enhancement layer arranged adjacent to the positive current collector layer, wherein the first conductive enhancement layer is a light transmissive layer.

5. The dimming structure according to claim 4, wherein the first conductive enhancement layer is arranged on a side of the positive current collector layer away from the positive pole.

6. The dimming structure according to claim 5, wherein the first conductive enhancement layer is provided with a patterned structure.

7. The dimming structure according to claim 6, wherein multiple second via holes are arranged in the first conductive enhancement layer, and a portion of the positive pole is located inside the second via holes.

8. The dimming structure according to claim 4, wherein the first conductive enhancement layer is arranged between the positive current collector layer and the positive pole.

9. The dimming structure according to claim 4, wherein multiple first via holes are arranged in the positive current collector layer, and a portion of the first conductive enhancement layer is located inside the first via holes, or second via holes corresponding to the first via holes are arranged in the first conductive enhancement layer.

10. The dimming structure according to claim 4, further comprising:
a second conductive enhancement layer arranged adjacent to the negative current collector layer, wherein the second conductive enhancement layer is a light transmissive layer.

11. The dimming structure according to claim 10, wherein the second conductive enhancement layer is arranged on a side of the negative current collector layer away from the electrolyte layer.

12. The dimming structure according to claim 1, further comprising:
a second base substrate arranged on a side of the negative current collector layer away from the electrolyte layer.

13. The dimming structure according to claim 1, further comprising:
a first encapsulation layer, wherein the first encapsulation layer wraps the positive current collector layer, the positive pole, the electrolyte layer, and the negative current collector layer, and the first encapsulation layer is a light transmissive layer.

14.-17. (canceled)

18. A dimming device, comprising:
a dimming structure comprising:
a positive current collector layer configured to be connected with a first positive pole of a power supply;
a positive pole arranged on a side of the positive current collector layer;
an electrolyte layer arranged on a side of the positive pole away from the positive current collector layer; and
a negative current collector layer arranged on a side of the electrolyte layer away from the positive current collector layer, and configured to be connected with a first negative pole of the power supply;
wherein the positive current collector layer and the negative current collector layer are conductors, and the positive current collector layer, the positive pole, the electrolyte layer, and the negative current collector layer are all light transmissive layers:
a power supply electrically connected to the dimming structure; and
electric equipment electrically connected to the dimming structure.

19. The dimming device according to claim 18, wherein the power supply comprises a solar cell, and the solar cell comprises:
a positive electrode and a negative electrode, wherein the positive electrode is electrically connected to the positive current collector layer and the negative electrode is electrically connected to the negative current collector layer; and
a hole transport layer, a photoelectric conversion layer, and an electron transport layer arranged in stacked manner in sequence, wherein the hole transport layer is connected to the positive electrode, and the electron transport layer is connected to the negative electrode.

20. (canceled)

21. The dimming device according to claim 19, wherein the hole transport layer is arranged on a side of the positive current collector layer away from the positive pole, an orthographic projection of the hole transport layer on the positive current collector layer overlaps with an orthographic projection of the positive pole on the positive current collector layer, and the positive current collector layer is multiplexed as the positive electrode.

22. The dimming device according to claim 19, wherein the hole transport layer is arranged on a side of the positive current collector layer, an orthographic projection of the hole transport layer on the positive current collector layer does not overlap with an orthographic projection of the positive pole on the positive current collector layer, and the positive current collector layer is multiplexed as the positive electrode.

23. The dimming device according to claim 19, wherein the electron transport layer is arranged on a side of the negative current collector layer away from the electrolyte layer, an orthographic projection of the electron transport layer on the negative current collector layer overlaps with an orthographic projection of the electrolyte layer on the negative current collector layer, and the negative current collector layer is multiplexed as the negative electrode.

24. The dimming device according to claim 19, wherein the electron transport layer is arranged on a side of the negative current collector layer, an orthographic projection of the electron transport layer on the negative current collector layer does not overlap with an orthographic projection of the electrolyte layer on the negative current collector layer, and the negative current collector layer is multiplexed as the negative electrode.

25. The dimming device according to claim 19, wherein a gap is provided between the dimming structure and the solar cell.
